(19) United States
(12) Patent Application Publication
(10) Pub. No.: US 2024/0000116 A1
(43) Pub. Date: Jan. 4, 2024

(54) FAT REDUCED GROUND MUCILAGINOUS SEEDS AS AFFORDABLE BINDER

(71) Applicant: SOCIETE DES PRODUITS NESTLE S.A., Vevey (CH)

(72) Inventors: LINDA BRUTSCH, Lausanne (CH); JANA CHRISTINA KAMMERHOFER, Bern (CH); TERESA KURTZ, Hamburg (DE)

(21) Appl. No.: 18/255,762

(22) PCT Filed: Dec. 3, 2021
(86) PCT No.: PCT/EP2021/084207

§ 371 Date: Jun. 2, 2023

(30) Foreign Application Priority Data
Dec. 4, 2020 (EP) 20211994.7

(51) Int. Cl. A23L 7/126; A23L 25/00

(52) U.S. Cl. CPC A23L 7/126; A23L 25/20

(57) ABSTRACT

A method of making a food product, said method comprising mixing 1.0 to 20.0 wt % flaxseed and 80.0 to 99.0 wt % inclusions in water, wherein the flaxseed has a fat content of less than 30 wt %; shaping the mixture of flaxseed and inclusions by one Nor more of (i) molding, (ii) rolling and cutting, and/or (iii) extruding and cutting; and drying the mixture to form a food product. The invention further relates to a food product comprising between 1.0 to 20.0 wt % flaxseed, wherein said flaxseed comprises less than 30 wt % fat, and wherein said food product is devoid of animal products.

### INTRODUCTION

Recent times have seen great changes in snacking behavior amongst consumers. In particular, snacks are expected to not only have superior nutritional benefits, but also contain only natural ingredients, have a low number of calories, and be a convenient portion size.

A key ingredient in snacks such as muesli bars and crackers is the binder. Most binders are sugar-based and for that reason have a major impact on the caloric content of the product. There are currently very few clean label, non-sweet binders that are used in the snack food industry. Non-sweet binders that are commonly used include starch, starch gels, eggs or gluten but these binders are for a variety of reasons generally not well perceived by consumers.

There is a clear need to provide a non-sweet binder for sweet and savory snacks which can be incorporated into food products that meet the needs of today's consumer.

### SUMMARY OF INVENTION

The inventors have found that reduced fat mucilaginous seed material, particularly flaxseed material, has a surprisingly good binding performance in food products.

Accordingly, the invention relates to a method of making a food product, said method comprising mixing mucilaginous seeds and inclusions. The inclusions can be ingredients such as chickpeas or puffed amaranth.

Preferably, the invention relates to a method of making a food product, said method comprising mixing flaxseed and inclusions; and shaping the mixture of flaxseed and inclusions. Shaping may be performed by one or more of (i) molding, (ii) rolling and/or cutting, and/or (iii) extruding and/or cutting.

Preferably, the invention relates to a method of making a food product, said method comprising mixing flaxseed and inclusions; shaping the mixture of flaxseed and inclusions by one or more of (i) molding, (ii) rolling and cutting, and/or (iii) extruding; and drying to form a food product. The preferred form of drying is baking.

The invention further relates to a food product comprising between 1.0 to 20.0 wt % flaxseed and between 70.0 to 99.0 wt % inclusions, wherein said flaxseed comprises less than 30 wt % fat. Preferably, said food product is devoid of animal products.

The invention further relates to the use of flaxseed as a binder in a food product devoid of animal products, wherein said flaxseed has a fat content of less than 30 wt %, preferably less than 10 wt %, more preferably between 1 to 5 wt %.

### EMBODIMENTS OF THE INVENTION

The invention relates in general to a method of making a food product, said method comprising mixing mucilaginous seeds and inclusions.

Preferably, the invention relates to a method of making a food product, said method comprising mixing mucilaginous seeds and inclusions; and drying to form a food product.

Preferably, the invention relates to a method of making a food product, said method comprising mixing mucilaginous seeds and inclusions; shaping the mixture of mucilaginous seeds and inclusions; and drying to form a food product.

The mucilaginous seeds can be flaxseed, basil seed, chia seed, or mustard seed. Preferably, the mucilaginous seeds are flaxseed, chia seed, or basil seed. Most preferably, the mucilaginous seeds are flaxseed.

The invention further relates to a method of making a food product, said method comprising
a. Mixing flaxseed and inclusions in a liquid, preferably in water, wherein the flaxseed has a fat content of less than 30 wt %;
b. Shaping the mixture of flaxseed and inclusions;
c. Drying the mixture to form a food product.

In particular, the invention relates to a method of making a food product, said method comprising
a. Mixing 1.0 to 20.0 wt % flaxseed and 70.0 to 99.0 wt % inclusions in water, more preferably to 99.0 wt % inclusions in water, wherein said flaxseed has a fat content of less than 30 wt %;
b. Shaping the mixture of flaxseed and inclusions by one or more of (i) molding, (ii) rolling and/or cutting, and/or (iii) extruding and/or cutting;
c. Drying the mixture to form a food product.

The flaxseed may have a fat content of less than 10 wt %, preferably between 1 to 5 wt %. This reduction in fat content can be achieved by several methods known in the art. The flaxseed may have been pressed to form a presscake. Preferably, the flaxseed is flaxseed presscake. Alternatively, the flaxseed is solvent extracted.

In one embodiment, the flaxseed comprises less than 20 grams of fat per 100 grams of flaxseed, preferably less than 15 grams, preferably less than 10 grams, preferably less than 5 grams. In one embodiment, the flaxseed comprises between 1 to 20 grams of fat per 100 grams of flaxseed.

In one embodiment, the flaxseed comprises less than 350 kilocalories per 100 g flaxseed, preferably less than 300 kilocalories, preferably less than 250 kilocalories, preferably less than 200 kilocalories, preferably less than 160 kilocalories. In one embodiment the flaxseed comprises between 100 kilocalories to 350 kilocalories per 100 g flaxseed.

In one embodiment, the flaxseed comprises less than 1.8 grams of carbohydrate per 100 grams of flaxseed, preferably less than 1.5 grams, preferably less than 1.0 grams, preferably less than 0.5 grams. In one embodiment, the flaxseed comprises between 1 to 20 grams of carbohydrate per 100 grams of flaxseed.

In one embodiment, the flaxseed comprises more than 25 grams of protein per 100 grams of flaxseed, preferably more than 27 grams, preferably more than 29 grams, preferably more than 32 grams. In one embodiment, the flaxseed comprises between 25 to 40 grams of protein per 100 grams of flaxseed.

In one embodiment, the flaxseed comprises more than 30 grams of fiber per 100 grams of flaxseed, preferably more than 35 grams, preferably more than 40 grams, preferably more than grams. In one embodiment, the flaxseed comprises between 30 to 55 grams of fiber per 100 grams of flaxseed.

Flaxseed presscake has the advantage that it is devoid, or substantially devoid, of carbohydrates and sugars. The flaxseed presscake may be in the form of a flour.

Preferably, the flaxseed is hydrated in water before step 1a) to provide a flaxseed mixture. This step helps to form the binder gel, by hydrating fibres in the flaxseed and building up a gel network. Preferably, the flaxseed mixture comprises a total solid content of between 0.5 to 8.0 wt %, or between 2.0 to 6.0 wt %.

Fibres, particularly soluble fibres, are responsible for visco-elastic properties and thus, the binding properties. Preferably, the flaxseed has a fibre content greater than 30 wt %, preferably between to 85 wt %, more preferably between 40 to 60 wt %.

Food products of the invention mainly comprise inclusions. The food product may comprise about 90 wt % of inclusions.

The inclusions may comprise the same ingredient, or substantially the same ingredient, or at least 90% of the same ingredient.

The inclusion particle size can range from 0.5 mm to 2.0 cm, more preferably 0.5 mm to 1.0 cm.

The average particle size and average bulk density of the inclusions was found to have an influence on the performance of the flaxseed binder.

The average particle size of the inclusions may be between 1.0 mm to 20.0 mm, preferably between 5.0 to 10.0 mm.

The average bulk density of the inclusions may be between 0.5 to 1.0 g·cm³, preferably about g·cm³

Preferably, the water activity of the inclusions is less than 0.6.

The inclusions may be selected from chickpeas, puffed quinoa, and puffed amaranth, puffed rice, nuts, seeds, cereals, dried fruits, or vegetables, preferably chickpeas, puffed quinoa, and puffed amaranth. Food products with chickpea inclusions were found to bind together particularly well using a flaxseed presscake binder. Preferably, the inclusions are or comprise chickpea.

The use of a flaxseed presscake binder allows the reduction of overall sugar content in the food product. Preferably, the food product is devoid or substantially devoid of added sugar, wherein added sugar is defined as an ingredient comprising at least 90 wt % sucrose. Said ingredient may or may not be an inclusion.

Preferably, the mixture is dried by baking to form a food product, for example by baking at about 100° C. for about 30 minutes.

Preferably, the food product is a vegetarian or vegan food product.

The invention further relates to a food product comprising flaxseed and inclusions, wherein said flaxseed comprises less than 30 wt % fat.

Preferably, the invention relates to a food product comprising between 1.0 to 20.0 wt % flaxseed and 70.0 to 99.0 wt % inclusions, more preferably 80.0 to 99.0 wt % inclusions, wherein said flaxseed comprises less than 30 wt % fat. The flaxseed may have a fat content of less than 10 wt %, preferably between 1 to 5 wt %.

The flaxseed presscake may be in the form of a flour.

Preferably, the flaxseed mixture comprises a total solid content of between 0.5 to 8.0 wt %, or between 2.0 to 6.0 wt %.

Preferably, the flaxseed has a fibre content greater than 30 wt %, preferably between 30 to 85 wt %, more preferably between 40 to 60 wt %.

The food product may comprise about 90 wt % of inclusions.

The inclusions may comprise the same ingredient, or substantially the same ingredient, or at least 90% of the same ingredient.

The inclusion particle size can range from 0.5 mm to 2.0 cm, more preferably 0.5 mm to 1.0 cm.

The average particle size of the inclusions may be between 1.0 mm to 20.0 mm, preferably between 5.0 to 10.0 mm.

The average bulk density of the inclusions may be between 0.5 to 1.0 g·cm³, preferably about 0.75 g·cm³

Preferably, the water activity of the inclusions is less than 0.6.

The inclusions may be selected from chickpeas, puffed quinoa, and puffed amaranth, puffed rice, nuts, seeds, cereals, dried fruits, or vegetables, preferably chickpeas, puffed quinoa, and puffed amaranth. Preferably, the inclusions are or comprise chickpea.

Preferably, the food product has a sucrose content of less than 5.0 wt %.

Preferably, the food product is a snack bar or a cracker.

Preferably, the food product is devoid of animal products.

The invention further relates to the use of flaxseed as a binder in a food product, wherein said flaxseed has a fat content of less than 30 wt %, preferably less than 10 wt %, more preferably between 1 to 5 wt %.

The flaxseed may have been pressed to form a presscake. Preferably, the flaxseed is flaxseed presscake. Alternatively, the flaxseed is solvent extracted.

The flaxseed presscake may be in the form of a flour.

Preferably, the flaxseed is hydrated in water before step 1a) to provide a flaxseed mixture.

Preferably, the flaxseed mixture comprises a total solid content of between 0.5 to 8.0 wt %, or between 2.0 to 6.0 wt %.

Preferably, the flaxseed has a fibre content greater than 30 wt %, preferably between 30 to 85 wt %, more preferably between 40 to 60 wt %.

The food product may comprise about 90 wt % of inclusions.

The inclusions may comprise the same ingredient, or substantially the same ingredient, or at least 90% of the same ingredient.

The inclusion particle size can range from 0.5 mm to 2.0 cm, more preferably 0.5 mm to 1.0 cm.

The average particle size of the inclusions may be between 1.0 mm to 20.0 mm, preferably between 5.0 to 10.0 mm.

The average bulk density of the inclusions may be between 0.5 to 1.0 g·cm³, preferably about g·cm³.

Preferably, the water activity of the inclusions is less than 0.6.

The inclusions may be selected from chickpeas, puffed quinoa, and puffed amaranth, puffed rice, nuts, seeds, cereals, dried fruits, or vegetables, preferably chickpeas, puffed quinoa, and puffed amaranth. Food products with chickpea inclusions were found to bind together particularly well using a flaxseed presscake binder. Preferably, the inclusions are or comprise chickpea.

Preferably, the food product is devoid or substantially devoid of added sugar, wherein added sugar is defined as an ingredient comprising at least 90 wt % sucrose. Said ingredient may or may not be an inclusion.

Preferably, the mixture is dried by baking to form a food product, for example by baking at about 100° C. for about 30 minutes.

### DETAILED DESCRIPTION OF THE INVENTION

Further description is provided below for the features of the invention and, where appropriate, apply to all product, method, and use embodiments.

As used herein, mucilaginous seeds can be flaxseed, basil seed, chia seed, or mustard seed. Preferably, the mucilaginous seeds are flaxseed, chia seed, or basil seed. Most preferably, the mucilaginous seeds are flaxseed.

The mucilaginous seeds have a fat content of less than 30 wt %, more preferably less than 25 wt %, more preferably less than 20 wt %, more preferably less than 15 wt %, more preferably less than wt %, most preferably the fat content is between 1 to 5 wt %. This reduction in fat content can be achieved by several methods known in the art. Preferably, the mucilaginous seed is pressed to form a presscake. Presscake may be defined as the remaining material after oil extraction by pressing of the mucilaginous seed. Alternatively, the mucilaginous seed can be solvent extracted, or pressed and solvent extracted.

As used herein, and unless otherwise stated, the term wt % refers to dry weight of an ingredient or component per 100 g. For example, mixing 1.0 to 20.0 wt % flaxseed and 80.0 to 99.0 wt % inclusions refers to mixing 1.0 to 20.0 g dry weight of flaxseed and 80.0 to 99.0 g dry weight of inclusions per 100 g dry weight of food product. Also, flaxseed having a fat content of less than 30 wt % refers to flaxseed comprising less than 30 g dry weight of fat per 100 g dry weight of flaxseed.

Preferably, the mucilaginous is mixed separately in water to provide a mixture comprising a total solid content of less than 10 wt %, or between 0.5 to 8.0 wt %, or between 2.0 to 6.0 wt %.

Fibres, particularly soluble fibres, are responsible for visco-elastic properties and thus, the binding properties. Preferably, the mucilaginous seed has a fibre content greater than 30 wt %, preferably between 30 to 85 wt %, more preferably between 40 to 60 wt %.

Preferably, the food product comprises about 90 wt % of inclusions.

The inclusion particle size can range from 0.5 mm to 2.0 cm. Ingredients with very small particle size like salt are not regarded as inclusions.

Preferably, the average particle size of the inclusions is between 1.0 mm to 20.0 mm, preferably between 3.0 to 15.0 mm, more preferably between 5.0 to 10.0 mm.

Preferably, the average bulk density of the inclusions is between 0.5 to 1.0 g·cm³, more preferably about 0.75 g·cm³.

Preferably, the water activity of the inclusions is less than 0.6.

Preferably, the inclusions are selected from chickpea, puffed quinoa, and puffed amaranth, puffed rice, nuts, seeds, cereals, dried fruits, or vegetables, preferably chickpea, puffed quinoa, and puffed amaranth. Most preferably, the inclusions are or comprise chickpea.

Preferably, the average particle size of the inclusions is between 5.0 to 10.0 mm, the average bulk density of the inclusions is about 0.7 g·cm³, and the inclusions are or comprise chickpeas.

Preferably, the water activity of the food product is less than 0.6.

The definition of certain terminology used within the present application is provided below.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or -1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

As used herein, “substantially devoid” means being present in an amount less than 0.1 wt %, more preferably 0.05 wt %, more preferably being completely absent.

The term “vegetarian” refers to an edible composition which is entirely devoid of meat or fish products. The term “vegan” refers to an edible composition which is entirely devoid of animal products, or animal derived products. Non-limiting examples of animal products include meat, fish, eggs, milk, and honey.

### EXAMPLES

By way of example and not limitation, the following examples are illustrative of various embodiments of the present invention.

### Example 1

### Breakage Test of Savory Snack Products

A 3-point-bending test was used to characterize the bending and breaking properties of the savory snack products of the invention (crackers). It involved placing a sample on two supports or points and recording the force needed to deform the sample when applying a load at equal distance from the 2 supports. The analysis was carried out with a TA TXT plus texture analyzer (Stable micro systems, Godalming, UK) and analyzed with EXPONENT software (Stable micro systems, Godalming, UK). The dimensions of the samples were approximately 35 mm in diameter and between 7 to 8 mm in height. The spacing between the two supports was 30 mm. The different value of diameter and height are important to ensure the repeatability of the measurements. The necessary force to break the sample was determined. The parameters used for the method with a 5 kg load cell are shown in Table 1.

TABLE 1

| Test Mode | Compression | |
|---|---|---|
| Pre-Test Speed | 1.00 | mm/sec |
| Test Speed | 0.50 | mm/sec |
| Post-Test Speed | 10 | mm/sec |
| Target Mode | Distance | |
| Distance | 10 | mm |
| Trigger Type | Auto (Force) | |
| Trigger Force | 0.049 | N |

| | |
|---|---|
| Advanced Options | Off |

Particle size was measured manually using a caliper. The diameter of 25 particles was measured and averaged. To determine the bulk density of the raw materials, the empty weight of a 100 ml glass cylinder was determined, filled with 100 ml of raw material and weighed again. The density was determined in triplicate.

### Example 2

### Stability of Cracker Products

The composition of the flaxseed presscake and (full fat) flaxseed meal binders used as ingredients to make the crackers are shown in Table 2.

TABLE 2

| | Flaxseed presscake in 100 g | Flaxseed meal in 100 g |
|---|---|---|
| Energy [kcal] | 158 | 510 |
| Fat [g] | 2 | 40 |
| Carbs [g] | 0 | 2 |
| Prot [g] | 35 | 22 |
| Fibres [g] | 50 | 27 |
| Sugars [g] | 0 | 2 |

Flaxseed meal and fat reduced presscake binders were prepared as shown in Table 3 in order to align on fibre content.

TABLE 3

| | Flaxseed presscake | Flaxseed meal |
|---|---|---|
| TS [%] | 4.35 | 8.61 |
| Fat free TS [%] | 4.25 | 4.91 |
| Fibre content | 2.5 | 2.5 |
| [%] | | |

The particle size and density of the ingredients (inclusions) used to make the crackers are shown in Table 4.

TABLE 4

| | Mean diameter | Stdev | Bulk density | Stdev |
|---|---|---|---|---|
| Inclusion | [mm] | [mm] | [g/cm³] | [g/cm³] |
| Puffed quinoa | 2.80 | 0.46 | 0.16 | 0.00 |
| Puffed amaranth | 1.62 | 0.20 | 0.19 | 0.00 |
| Raw chickpeas | 7.63 | 0.34 | 0.77 | 0.01 |

Crackers were produced by mixing all the ingredients, molding, and drying at 100° C. for 30 minutes.

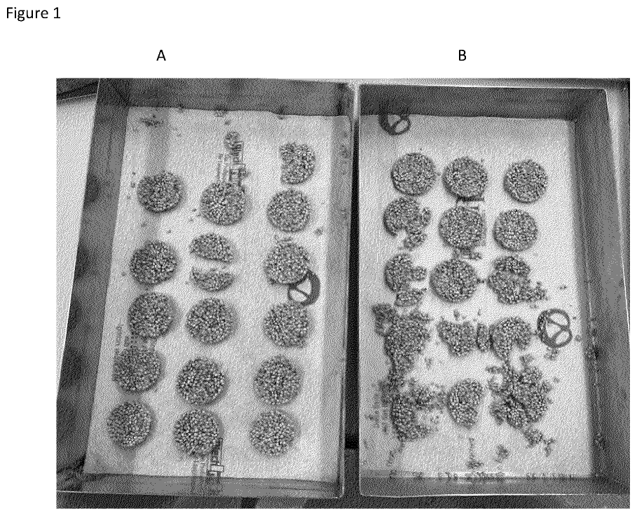

In a first test, 40 grams binder and 60 grams quinoa pops were mixed. Only 2 crackers out of 16 produced with presscake binder were broken (FIG. 1A), whereas 9 out of 15 crackers produced with full fat flaxseed meal binder were broken (FIG. 1B). Crackers made with presscake binder were therefore judged to be the most stable.

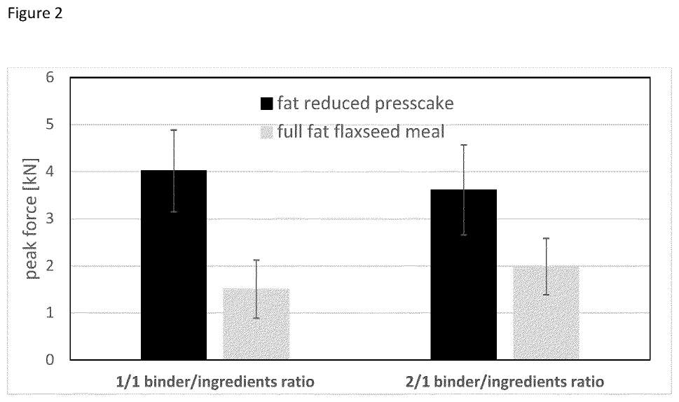

The effect of varying binder quantity on binding strength was assessed. Wet binder and ingredients were mixed in a 1:1 ratio (50 g binder+50 g quinoa pops). For the presscake, this equated to 4.17% dry binder in the cracker. For the full fat flax meal, this equated to 7.93% dry binder in the cracker. Wet binder and ingredients were also mixed in a 2:1 ratio (67 g binder+33 g quinoa pops). For the presscake, this equated to 8.12% dry binder in the cracker. For the full fat flax meal, this equated to 14.88% dry binder in the cracker. Fat reduced presscake binder displayed a higher peak force, meaning that the crackers with that binder had higher stability and better binding strength compared to crackers with full fat flaxseed meal binder. No significant difference could be seen by increasing the binder:ingredient ratio from 1:1 to 2:1 (FIG. 2)

The effect of varying the size of ingredients on binding strength was assessed. Wet binder and ingredients were mixed in a 1:1 ratio (50 g binder+50 g quinoa pops or amaranth pops). For the presscake, this equated to 4.17% dry binder in the cracker. For the full fat flax meal, this equated to 7.93% dry binder in the cracker.

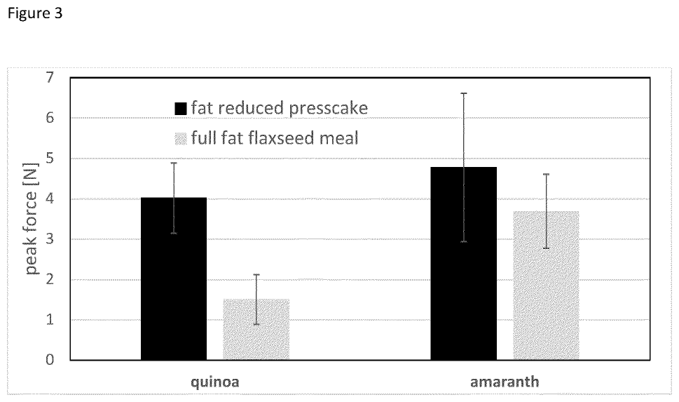

The performance of both binders was similar for ingredients with the smaller amaranth particles. There was a noticeable trend of better binding strength with presscake compared to full fat meal, but there was no significant difference due to high standard deviations (FIG. 3).

The effect of varying the size and density of ingredients on binding strength was assessed. Wet binder and quinoa pop ingredients were mixed in a 1:1 ratio (50 g binder+50 g quinoa pops). For the presscake, this equated to 4.17% dry binder in the cracker. For the full fat flax meal, this equated to 7.93% dry binder in the cracker. Wet binder and chickpea ingredients were mixed in a 1:3 ratio (25 g binder+75 g chickpeas). For the presscake, this equated to 1.43% dry binder in the cracker. For the full fat flax meal, this equated to 2.79% dry binder in the cracker.

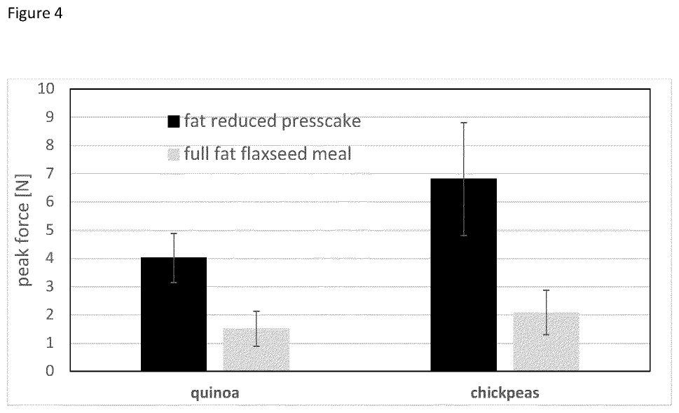

Although the binding strength could not be directly compared due to different binder quantities, it could be seen that improved binding through presscake (compared to full fat meal) was more pronounced for the larger and more dense chickpea ingredients (FIG. 4).

### Example 3

### Comparison of Full Fat Flaxseed Meal, Semi Defatted Meal and Defatted Presscake

Composition of presscake and full flaxseed meal

| In 100 g | Defatted presscake | Semi fat meal | Full fat meal |
|---|---|---|---|
| Energy [kcal] | 158 | 331 | 510 |
| Fat [g] | 2 | 13 | 40 |
| Carbs [g] | 0 | 1 | 2 |
| Prot [g] | 35 | 30 | 22 |
| Fibers [g] | 50 | 41 | 27 |
| Sugars [g] | 0 | 1 | 2 |

Binder preparation

Binders were prepared in order to align on fiber content

| Binder with | Defatted presscake | Semi fat meal | Full fat meal |
|---|---|---|---|
| TS [%] | 4.35 | 6.12 | 8.61 |
| Fat free TS [%] | 4.25 | 5.35 | 4.91 |
| Fiber content | 2.5 | 2.5 | 2.5 |
| [%] | | | |

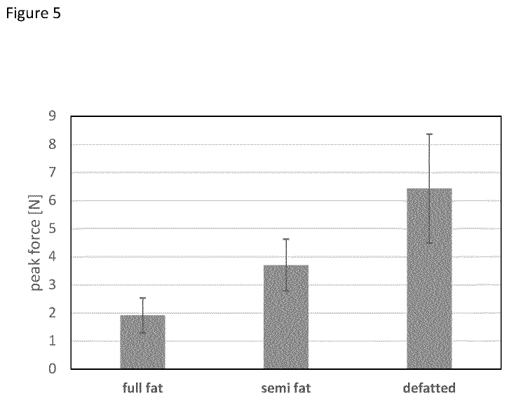

Binding strength is shown in FIG. 5.

1/1 wet binder/ingredients ratio: 50 g binder+50 g quinoa pops
defatted: 4.17% dry binder in cracker
semi fat: 5.77% dry binder in cracker
Full fat: 7.93% dry binder in cracker

1. A method of making a food product, said method comprising
a. Mixing 1.0 to 20.0 wt % flaxseed and 80.0 to 99.0 wt % inclusions in water, wherein the flaxseed has a fat content of less than 30 wt %;
b. Shaping the mixture of flaxseed and inclusions by one or more steps selected from the group consisting of (i) molding, (ii) rolling and cutting, and/or (iii) extruding and cutting; and
c. Drying the mixture to form a food product.

2. The method according to claim 1, wherein the flaxseed has a fat content of between 1 to 5 wt %.

3. The method according to claim 1, wherein the flaxseed is flaxseed presscake.

4. The method according to claim 1, wherein the flaxseed is hydrated in water before step 1a) to provide a flaxseed mixture comprising a total solid content of between 2.0 to 6.0 wt %.

5. The method according to claim 1, wherein the flaxseed has a fibre content between 40 to 60 wt %.

6. The method according to claim 1, wherein the average particle size of the inclusions is between 5.0 to 10.0 mm.

7. The method according to claim 1, wherein the average bulk density of the inclusions is between 0.5 to 1.0 g·cm³.

8. The method according to claim 1, wherein the inclusions are or comprise chickpea.

9. The method according to claim 1, wherein the food product is devoid of added sugar, wherein added sugar is defined as an ingredient comprising at least 90 wt % sucrose.

10. The method according to claim 1, wherein the food product is a vegetarian or vegan food product.

11. A food product comprising between 1.0 to 20.0 wt % flaxseed and between 80 to 99.0 wt % inclusions, wherein said flaxseed comprises less than 30 wt % fat.

12. Food product according to claim 11, wherein said food product has a sucrose content of less than 5.0 wt %.

13. Food product according to claim 11, wherein said food product is a snack bar or a cracker.

14. Food product according to claim 11, wherein said food product is devoid of animal products.

15. (canceled)
